(19) United States
(12) Patent Application Publication
(10) Pub. No.: US 2011/0017532 A1
(43) Pub. Date: Jan. 27, 2011

(54) A HYBRID POWERTRAIN

(75) Inventors: Richard Langford, Northhamptonshire (GB); Christopher Booth Delaney, Liverpool (GB)

Correspondence Address: JEFFER, MANGELS, BUTLER & MITCHELL, LLP, 1900 AVENUE OF THE STARS, 7TH FLOOR, LOS ANGELES, CA, 90067, US

(73) Assignee: LANGFORD PERFORMANCE ENGINEERING LIMITED, Wellingborough, Northhamptonshire (UK)

(21) Appl. No.: 12/682,970

(22) PCT Filed: Oct. 15, 2008
(86) PCT No.: PCT/GB2008/003495

§ 371 Date: Jul. 14, 2010

(30) Foreign Application Priority Data
Oct. 15, 2007 (GB) 0720151.0

(51) Int. Cl. B60K 6/00; B60W 20/00

(52) U.S. Cl. 180/65.21; 903/930

(57) ABSTRACT

A hybrid powertrain (10) comprises an electric motor (12) which drives a set of wheels (22) of a vehicle, and energy storage means (24) electrically connected to the electric motor (12) to provide a supply of electrical energy to the electric motor (12). The hybrid vehicle motor further comprises one or more gas turbines (32) electrically connected to the energy storage means (24) and adapted to generate electrical energy for storing in the energy storage means (24).

The present invention relates to hybrid vehicles and particularly hybrid powertrains.

Currently, the majority of vehicles are driven by four stroke internal combustion engines which have relatively high carbon emissions. The current environmental climate necessitates development of vehicles which emit lower, or zero, carbon emissions.

Developments in this technical field include all-electric vehicles having electric motors powered by energy stored in on-board rechargeable energy storage systems (RESS). The RESS are charged by an external electrical source. However, such vehicles are limited in range and by the off-road facilities needed for recharging the RESS.

Recent developments have also included hybrid vehicles having more than one fuelled power source for vehicle propulsion, commonly known as Hybrid-Electric Vehicles (HEVs). An example of such a vehicle is petroleum-electric hybrid, which has an electric motor and an internal combustion engine. An HEV typically maintains the charge in the batteries by storing kinetic energy from regenerative braking when slowing the vehicle down. Additionally, the internal combustion engine, by way of a generator, generates electricity, which is used to recharge the RESS or feed power directly to the electric motor driving the wheels of the vehicle.

However, use of conventional four stroke internal combustion engine remains undesirable if zero, or near to zero, carbon emissions are to be achieved for motor vehicles. Furthermore, it is desirable for the means for the motor to be lightweight, be vibration fee, be smaller in size, have fewer parts, be easily and relatively inexpensive to maintain, have a long life and not require a warm up period following a cold start.

According to the present invention there is provided a hybrid powertrain comprising an electric motor, for driving a set of wheels of a vehicle, and energy storage means electrically connected to the electric motor for providing a supply of electric energy to the electric motor, wherein the hybrid vehicle motor further comprises at least one micro turbine electrically connected to the energy storage means and adapted to generate electrical energy for storing in the energy storage means.

The electric motor may comprise a permanent magnet D.C. or A.C. motor.

The hybrid powertrain advantageously further comprises an operating controller operable to maintain rotation of the gas turbine at a substantially constant speed. The gas turbine is advantageously fuelled with a bio-fuel such as, for example, bio-diesel or bio-ethanol, made from, for example, oil seed rape, sunflower seed or any other suitable material, which facilitates zero, or near zero, carbon emissions.

The energy storage means is preferably rechargeable and may comprise at least one battery bank. The, or each, battery bank which is advantageously cooled and arranged in a compact and space-saving layout may comprise a plurality of batteries. The, or each battery may be a lithium ion battery.

The hybrid powertrain may further comprise an energy output controller operable to monitor and control the flow of electrical charge between the electric motor and the energy storage means. In addition to electrical energy flowing from the energy storage means to the motor, electrical energy may also flow from the motor to the energy storage means, wherein electrical energy is generated by the electric motor during braking or slowing of the vehicle, which is advantageously controlled by a battery management system. The turbine generator/battery interface is preferably controlled by software which advantageously provides either a constant charging rate or a variable charging rate dependent upon demand. The rate of charge is advantageously determined by monitoring the traction motor load drawn from the battery bank over a period of time so that the processor may instruct the turbine to match the rate of charge to that required without either excessive drain on the battery cells nor an increase in temperature of the batteries above a predetermined temperature, for example 40° C. The traction motor load is advantageously monitored over a period of several milliseconds at a time.

The hybrid powertrain may also comprise mechanical/electrical conversion means operable to convert mechanical energy and electrical energy between the gas turbine and the electrical storage means. The mechanical/electrical conversion means may comprise and alternator and may also comprise an AC to DC electric converter.

The hybrid powertrain may further comprise monitoring means operable to monitor one or more of the battery charge/discharge and temperature, regenerative energy, battery charge voltage, current discharge and the state of the cells in the battery bank, turbine status and the electric motor.

The hybrid vehicle motor may further comprise mechanical means for optimising the torque ratio between the electric motor and the wheels. The mechanical means may comprise a transmission system and a clutch. The mechanical means is advantageously a manual multi-speed gearbox.

The gas turbine may operate simultaneously with the electric motor, as the motor drives the vehicle wheels, or independently of the electric motor, when the motor is at rest to continue charging the electrical storage means.

The present invention will now be described in more detail with reference to the following drawing, in which:

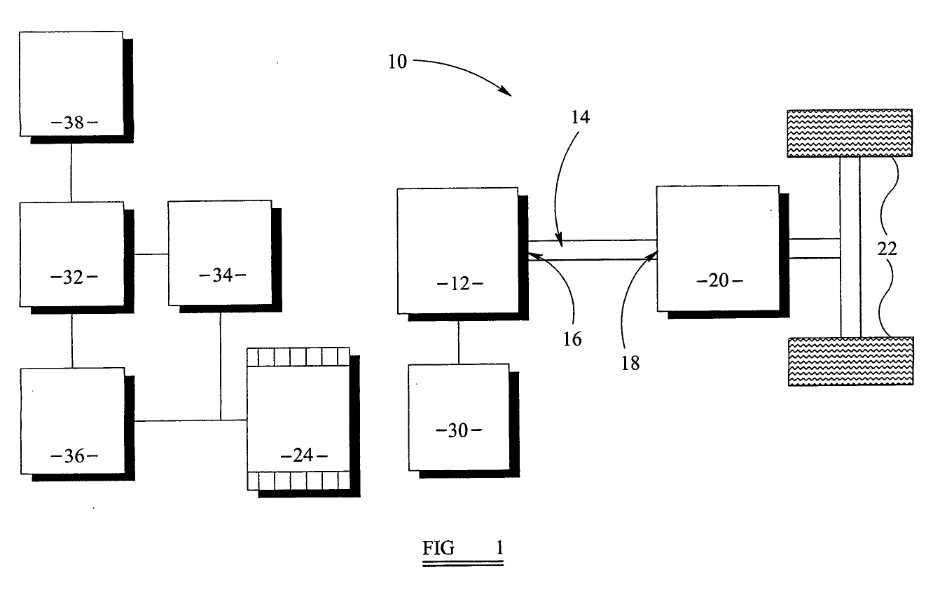

FIG. 1 is a schematic drawing of a hybrid powertrain according to the present invention; and

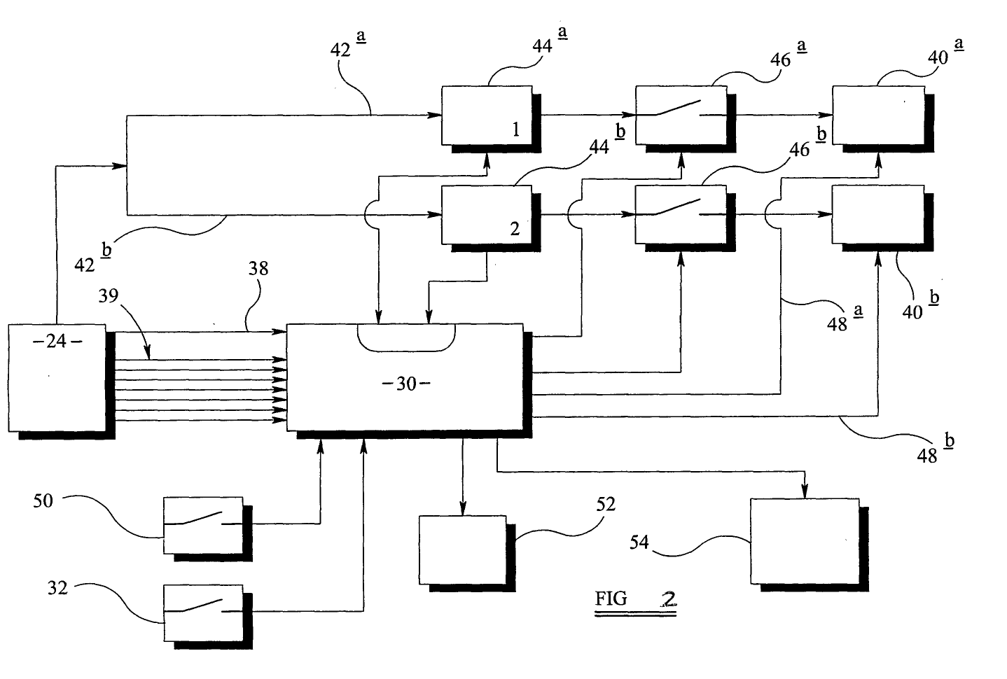

FIG. 2 is a schematic of a controller for controlling the hybrid powertrain of FIG. 1.

Referring to FIG. 1, a hybrid powertrain 10 comprises a direct current electric motor 12 having a drive shaft 14 extending therefrom. The drive shaft has a first end 16 and a second end 18. The first end 16 is rotatably coupled to the motor 12 and the second end 18 is coupled to mechanical means 20 for rotatably driving a set of vehicle wheels 22. The horsepower of the motor 12 is predetermined relative to the weight of the vehicle, which it is intended to drive.

The mechanical means 20 has a transmission system and a clutch. The mechanical means provides for manual or automatic adjustment of the torque ratio between the motor 12 and the wheels 22.

The hybrid powertrain 10 further comprises rechargeable energy storage means 24 in the form of a battery pack. The energy storage means 24 is electrically connected to the motor 12 through an energy storage controller 30. The energy storage controller 30 controls the quantity and flow of electricity from the energy storage means 24 to the electrical motor 12.

Electricity is generated by a gas turbine 32 fuelled with a diesel or bio-fuel such as bio-diesel. Although it will be appreciated that other bio-fuels may be equally applicable to fuelling the gas turbine within the working of the present invention.

The gas turbine 32 is electrically connected to the energy storage means 24 through mechanical/electrical conversion means 34. The mechanical/electrical conversion means 34 includes an alternator and an AC to DC converter such that mechanical rotation of the gas turbine is converted into an AC energy supply which is subsequently converted, by the AC to DC converter, into a DC supply for storing in energy storage means 24. An energy input controller 36 monitors the energy stored in the energy storage means 24 and controls the demand for generated electricity.

The gas turbine 32 further comprises an operating controller 38 which monitors the operation of the gas turbine 32 to ensure it rotates at a constant speed. Operating the gas turbine 32 at a constant speed increases efficiency and enables the hybrid vehicle motor 10 to drive a vehicle having zero, or near zero, carbon emissions.

Electricity is also generated by the electric motor 12 during braking or slowing of the vehicle. This regenerative braking energy flows from the motor 12 to the rechargeable energy storage means 24. The energy storage controller 30 controls the quantity and flow of regenerative braking energy from the motor 12 to the rechargeable energy storage means 24.

Referring also to FIG. 2, the controller 30 is electrically connected 38 to the battery bank to provide power through the controller 30 to power devices 40 for driving the electric motor 12.

The voltage and temperature of the battery bank 24 is monitored and fed into the controller 30.

The power devices 40a and 40b are powered by the battery bank 24 through one of two individually selectable power paths; a low power path 42a and a high power path 42b.

The low and high power paths, 42a and 42b, each have current sensors 44a and 44b, respectively, for measuring the traction motor load and therefore the rate at which charge is being drawn from the battery.

Both current sensors 44a and 44b are connected to the controller.

The controller 30 also has safety cut off disconnecting devices 46a and 46b connected in the low and high power paths in series between the current sensors 44a and 44b and the power devices 40a and 40b, respectively.

The controller 30 activates the cut off devices 46a and 46b in situations when it is required to immediately stop the power to the power devices 40a and 40b.

The controller 30 further comprises a direct controlling link 48a and 48b to the power devices 40a and 40b respectively.

The controller 30 further comprises electrical connections to the ignition system 50 and the turbine 32 and also to a driver display 52 and an on-board vehicle computer 54 which controls other features of the vehicle.

In use the controller 30 monitors the battery voltages and temperatures 39 and the traction motor load by measuring the current 44a and 44b and controls the turbine 32 to ensure that the battery bank 24 is sufficiently charged to power the power devices 40a and 40b whilst ensuring the temperature of the battery bank does not exceed 40° C.

A hybrid motor vehicle according to the present invention is approximately half the weight and size and produces approximately one-third less emissions than a conventional diesel arrangement. This is particularly advantageous as it allows a hybrid vehicle to travel approximately 45 miles on electrical power from on-board batteries alone and achieve fuel consumption figures in excess of 80 miles per gallon.

1. A hybrid powertrain comprising an electric motor, for driving a set of wheels of a vehicle, and energy storage means electrically connected to the electric motor for providing a supply of electric energy to the electric motor, wherein the hybrid vehicle motor further comprises at least one micro turbine electrically connected to the energy storage means and adapted to generate electrical energy for storing in the energy storage means.

2. A hybrid powertrain as claimed in claim 1, comprising an operating controller operable to maintain rotation of the gas turbine at a substantially constant speed.

3. A hybrid powertrain as claimed in claim 1 or 2, wherein the gas turbine is fuelled with a diesel or bio-fuel.

4. A hybrid powertrain as claimed in claim 3, wherein the bio-fuel is selected from one of bio-diesel or bio-ethanol.

5. A hybrid powertrain as claimed in any of the preceding claims, wherein the energy storage means is rechargeable.

6. A hybrid powertrain as claimed in any of the preceding claims wherein the energy storage means comprises at least one battery bank.

7. A hybrid powertrain as claimed in claim 6, wherein the, or each, battery bank comprises a plurality of batteries.

8. A hybrid powertrain as claimed in claims 6 to 7 wherein the energy storage means comprises one or more lithium ion batteries.

9. A hybrid powertrain as claimed in any of the preceding claims, comprising an energy output controller operable to monitor and control the flow of electrical energy between the electrical motor and the energy storage means.

10. A hybrid powertrain as claimed in any of the preceding claims comprising a battery management system operable to monitor and control the flow of electrical charge from the gas turbine to the energy storage means.

11. A hybrid powertrain as claimed in any of the preceding claims comprising mechanical/electrical conversion means operable to convert mechanical energy and electrical energy between the gas turbine and the energy storage means.

12. A hybrid powertrain as claimed in claim 11, wherein the mechanical/electrical conversion means comprises an alternator.

13. A hybrid powertrain as claimed in claim 11 or 12, wherein the mechanical/electrical conversion means comprises an electrical AC to DC converter.

14. A hybrid powertrain as claimed in any preceding claim, comprising mechanical means having transmission means and a clutch for manual or automatic adjustment of the torque ratio between the motor and the wheels.

15. A hybrid powertrain as claimed in any preceding claim wherein the electric motor comprises a permanent magnetic DC motor.

16. A hybrid powertrain as claimed in any preceding claim further comprising a control means operable to monitor and control the rate of charge of the battery bank relative to the traction motor load.

17. A hybrid powertrain as claimed in claim 16 wherein the control means is operable to control the rate of charge such that the turbine charges the battery sufficiently to match the traction motor load whilst the temperature of the battery bank is monitored below 40° C.

18. A hybrid powertrain as claimed in claim 16 or 17 wherein the control means is operable to monitor the traction motor load for no more than several milliseconds at a time.

19. A vehicle comprising a hybrid powertrain as claimed in any preceding claim.

20. A method of controlling a hybrid powertrain comprising:
monitoring the traction motor load; controlling a turbine charger such as to charge a battery bank relative to the traction motor load; and, monitoring the temperature of the battery bank at or below 40° C.
